(19) United States
(12) Patent Application Publication
(10) Pub. No.: US 2007/0156613 A1
(43) Pub. Date: Jul. 5, 2007

(54) Time conditioned display of time-related information such as hours of operation for a business

(76) Inventor: Michael John Safoutin, Seattle, WA (US)

Correspondence Address: MICHAEL J. SAFOUTIN, 4137 UNIVERSITY WAY NE, APT. E, SEATTLE, WA, 98105, US

(21) Appl. No.: 11/650,107

(22) Filed: Jan. 5, 2007

Related U.S. Application Data
(60) Provisional application No. 60/756,694, filed on Jan. 5, 2006.

(51) Int. Cl. G07B 17/02

(52) U.S. Cl. 705/411

(57) ABSTRACT

A method for display of time-related information, such information being descriptive of one or more predictable states of a described subject as a function of time, includes representation of said time-related information relating one or more states of the subject to a representation of time, determination of a time condition applicable to evaluation of said time-related information for the purpose of identifying the corresponding state(s), identification of one or more indicated state(s) corresponding to the time condition by means of evaluation of said time-related information with respect to the time(s) represented by the time condition, and representation of said indicated state(s) and/or said derived information on an information display.

### CROSS-REFERENCE TO RELATED APPLICATIONS

This application claims the benefit of U.S. Provisional Application No. 60/756,694 filed Jan. 5, 2006.

### STATEMENT REGARDING FEDERALLY SPONSORED RESEARCH OR DEVELOPMENT

Not Applicable

### TECHNICAL FIELD

The present invention relates to the determination and representation of one or more states of one or more subject(s), said subject(s) being characterizable as possessing one or more predictable state(s) that are dependent at least in part on a specified or implied time condition.

### BACKGROUND OF THE INVENTION

Display of information by means of the World Wide Web (WWW) is common in the art of information design. Web pages are typically hosted by a server computer (hereafter referred to as the server side) that is accessible to web browsing programs that run on client computers (hereafter referred to as the client side) that are connected to the internet. The client web browser receives text from the server and uses this text as source to compose the web page in the browser. Said text may, as is commonly known in the art, exist in the form of a text file that resides on the server. Alternatively, as is also commonly known in the art, part or all of said text may be dynamically generated by the server at the time the client requests it.

A rapidly growing sector in web development concerns web sites that display information about local places, businesses, and events, that are of interest to consumers. Web pages of this sort commonly include directory information such as place name, address, telephone number, and similar types of factual information. Also commonly, some of this information is inherently time-related, such as, for example, business hours (also known as hours of operation) that describe a weekly or similar schedule or set of time periods during which a business is scheduled to be open for business or closed to business; or, as another example, the scheduled time of an event such as a sale or a performance. The purpose for depicting such information is to provide to the viewer, i.e. the reader or user of the information display, the ability to determine the availability of the depicted subject (here, the business or event) at a specific time or time period that is of interest to the viewer.

Prior art representations of time-related information of these types have been limited to literal, descriptive representations such as “Business hours: 9 am to 5 pm, Monday thru Friday”, or a list or table of days of the week and a similar textual description of the corresponding opening and closing time for each day; or for an event, a textual description such as “appearing Tuesdays at 9 pm”. The viewer of such representations is left to perform the cognitive task of comparing a time of interest, such as the current time or an anticipated time of visit, to the time schedule described by the textual description, in order to determine whether the subject is available at the time of interest. Furthermore, because of this cognitive burden imposed by their interpretation, prior art representations are poor at conveying the time availability of multiple subjects in a way that allows the viewer to easily understand which subset of subjects are available or unavailable at a given time. For example, if a list of textually described business hours for a group of businesses are listed, the viewer must individually examine each in order to determine which are open or closed at a given time of interest. These shortcomings of the prior art apply equally well to other types of time-related information other than business hours, such as for example, scheduled events that occur on a one-time or repeating basis. For this type of time-related subject, the viewer may wish to determine the status of the event in terms of criteria such as whether the event occurs in the future, is happening now, or is past; and if future or past, relatively how far in the future or past; all relative to a time condition such as the current time, a different time, or a time period. Similarly to the case with business hours, prior art representations fail to easily convey these time-related aspects for the purpose of relating possible states to a time of interest or for comparing the time conditioned status of multiple events to each other.

### BRIEF SUMMARY OF THE INVENTION

The theory of operation of the invention is centered on the recognition that time-related information, particularly that which is descriptive of one or more states predictable as a function of time, may be converted to one or more indicated state(s) corresponding to a specified, assumed, or implied time condition, such as the current time or other point in time or period of time. Specifically, in a computational environment in which an information display may be dynamically composed, the indicated state(s) may be determined computationally by reference to said time condition and time-related information. The state(s) thus indicated as corresponding to the time condition might then be depicted instead of or in addition to the literal representation that is typically provided in the prior art. Furthermore, additional information might be derived in evaluating the relationship between the time condition and the time-related information, such as the amount of time remaining in the indicated state. Still further the time-related information might be visually depicted on a schedule such that each defined state may be visually expressed with respect to its corresponding scheduled times, so that the time condition may be viewed in the context of the time-related information, and so that other time conditions may be visually considered. The invention thereby acts to reduce the cognitive effort required of the viewer to determine the state of the subject of the information display relative to time(s) of interest.

The invention may be described most generally as having the following primary and optional aspects. A display method for time-related information, such information being descriptive of one or more predictable states of a described subject as a function of time, includes a representation of said time-related information relating one or more states of the subject to a representation of time; determination of a time condition applicable to evaluation of said time-related information; identification of one or more indicated state(s) corresponding to the time condition by means of evaluation of said time-related information with respect to the time(s) represented by the time condition; and representation of said indicated state(s) and/or said derived information on an information display.

Optionally, said evaluation derives additional information such as, for example, time remaining before the next scheduled change of state, and/or other types of derived information to be described herein. Also optionally, the time condition may include one or more time(s) or period(s) of time either (a) based upon the current server time or (b) specified by the user by means of a provided user interface. Also optionally, the time condition may be a current localized server time offset by an estimated travel time from the user's detected location and the location of the subject. Also optionally, the time-related information and/or the indicated state(s) may be depicted on a suitable schedule such as a weekly or monthly calendar schedule.

A preferred embodiment possesses the following set of specific primary and optional aspects. The information display is a world wide web page as viewed by means of an ordinary web browser. The described subject of the information display is a business such as, for example, a restaurant or clothing store. The time-related information is the hours of operation (business hours) for said business, expressed in terms of a weekly repeating schedule of opening and closing times in minutes past a base reference time such as, for example, 12:00 AM Monday. The time condition is the server time at time of display, localized if necessary to a local time corresponding with the locality of the business, and converted to a weekly schedule time in minutes relative to the reference time. Applicable states of the subject that the time-related information relates to time are a binary pair representing “open” (business is open to the public for business) and “closed” (business is closed to the public for business). An additional state representing “unknown” may be returned if the time-related information is unavailable or insufficient to identify either of the binary states as corresponding to the time condition.

Recognizing that business hours for a business may be understood as a type of event, in which the event is a weekly-recurring and regularly scheduled opening of the business to the public for a period of time, it may also be recognized that the above preferred embodiment applies equally well to any other sort of event that consists of one or more instances occurring on a one-time basis or a regularly repeating basis. In this case, the applicable states may be “future”, “happening now”, and “past”, instead of the binary pair “open” and “closed”.

The invention provides several new and useful advantages over the prior art. While the prior art method for representing, for example, the business hours of a business, has always consisted of a textual description or table that conveys scheduled times of opening and closing for each day of the week, the invention provides for a dynamic representation of this information in a way that requires less cognitive effort for the reader to interpret. For example, by means of the invention, an information display describing the business may be made to include a simulated “open/closed” sign, displaying “open” if the business is scheduled to be open at the time of composition or viewing of the information display, and similarly displaying “closed” if the business is scheduled to be closed. Furthermore, the “open” and “closed” state may be determined with respect to an expected travel time from the reader's geographic location to the geographic location of the business, such that the viewer perceives the likely open or closed state of the business at his or her earliest possible time of arrival. Still further, the respective states of multiple businesses may be displayed at once, so that the reader may determine at a glance which subset of businesses are open and which are closed. Still further, the provision of a schedule-based means of depiction for the weekly open and closed intervals of the business makes it possible to visually interpret the relative amount of time before a business opens and/or the relative amount of time before a business closes. These advantages apply equally well when the invention is applied to one-time or recurring events rather than to business hours of a business. These and other advantages of the invention over the prior art will become apparent on gaining a further understanding of the invention. The nonobvious nature of the invention is supported by the fact that, despite the proliferation of world-wide-web sites that intensely compete to compile and provide information about local businesses, including information about events and business hours, there are no current examples of such web sites that display time-related information such as business hours or events in the manner described herein, despite the aforementioned advantages in doing so.

### BRIEF DESCRIPTION OF THE SEVERAL VIEWS OF THE DRAWING

FIG. 1 shows one example of an information display that utilizes the invention, in which the status of the subject and additional derived information are displayed.

FIG. 2 shows another example of an information display that utilizes the invention, in which additionally to the information displayed in FIG. 1, a schedule of states is displayed.

FIG. 3 shows another example of an information display that utilizes the invention, in which multiple subjects and their respective states are displayed.

FIG. 4 shows an example of a data representation by which time information associated with a subject may be represented.

FIG. 5 details several portions of the data representation depicted in FIG. 4.

### DETAILED DESCRIPTION OF THE INVENTION

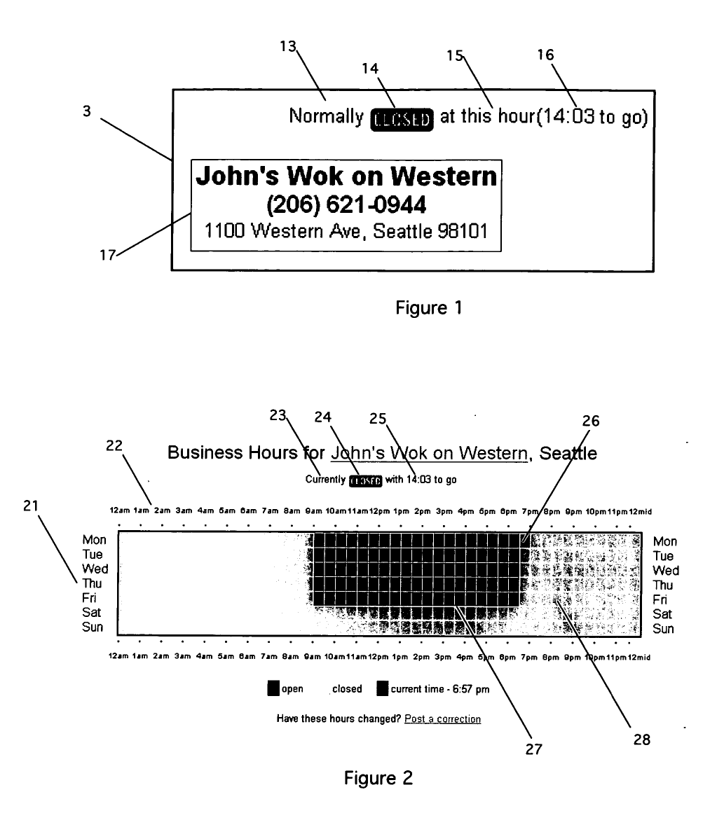

Referring to FIG. 1, web page 3 displays general information 17 pertaining to a subject business. By means of the invention the web page 3 also has been provided with a representation of time-related information, resulting from evaluation of time-related information associated with the subject business relative a time criterion. Specifically, graphic image 14 provides a representation of the indicated state of the business (open or closed) as evaluated at the time the request for the page was received from the client web browser. Text 13, 15, and 16 has also been provided to represent derived information discussed previously. The manner of display, web page content, and page design shown in FIG. 1 is for example only. Many page designs, accompanying content, and manner of display may be employed without departing from the spirit and scope of the invention. For example, the indicated state may be expressed by means of either graphic image or text, as well as may be the derived information. Any combination of information representing the indicated state and/or the various types of derived information disclosed above may be included on the page or omitted.

Optionally, the evaluation of time-related information may additionally include checks for the condition in which the schedule indicates that a change in state from the indicated state is particularly near or particularly recent relative the time condition. If this condition is detected, additional indicated states are returned and depicted in the information display. In this scenario, FIG. 1 would include additional text or graphic content representing secondary states such as, for example, “open soon” (applicable to represent a business that is closed with respect to the time condition but scheduled to open in a relatively short amount of time afterward), and “closing soon” (applicable to represent a business that is open with respect to the time condition but scheduled to close in a relatively short amount of time afterward). For example, if a small amount of schedule time remains before the business opens, that is, less than a specified or predetermined threshold time or percentage of time relative to a norm such as the duration of the next open period, a state such as “opening soon” would be returned and displayed. The specific threshold or percentage or other relation to be employed for this purpose may be specified in the code of the program or script, or optionally could be retrieved from a location on the internet or on the server, or specified and received by the script as part of the time-related information. Additionally and optionally, to represent the actual amount of schedule time remaining until a change in state relative the time condition, or to represent the actual amount of time elapsed since the indicated state began, additional information may be returned and displayed, such as, for example, “will be open for another 3 hours and 15 minutes”, or “closed 3 hours and 15 minutes ago”, or “has been open for 2 hours”. Also additionally and optionally, to represent the actual time of the previous or next scheduled time relative the time condition, additional information may be returned such as “closing at 3:00 pm” or “opening at 9:00 am”.

The preferred embodiment also provides for a schedule depiction of the time-related information. Preferably but not exclusively the depiction of indicated state and/or derived information is hyperlinked to a depiction of an appropriate schedule format such as that depicted for example in FIG. 2. Preferably but not exclusively the schedule is implemented as a dynamically generated HTML (hypertext markup language) table that expresses days of the week on a vertical or horizontal edge 21 and time of day on the perpendicularly oriented edge 22, and within which cells are colored uniquely to correspond to time periods during which the open state 27 and closed state 28 apply. The schedule depiction may also optionally depict in a unique color one or more cells 26 corresponding to the schedule time corresponding to the time condition. The schedule display may also optionally include text 23, 25 and/or graphical or other representation of indicated state 24.

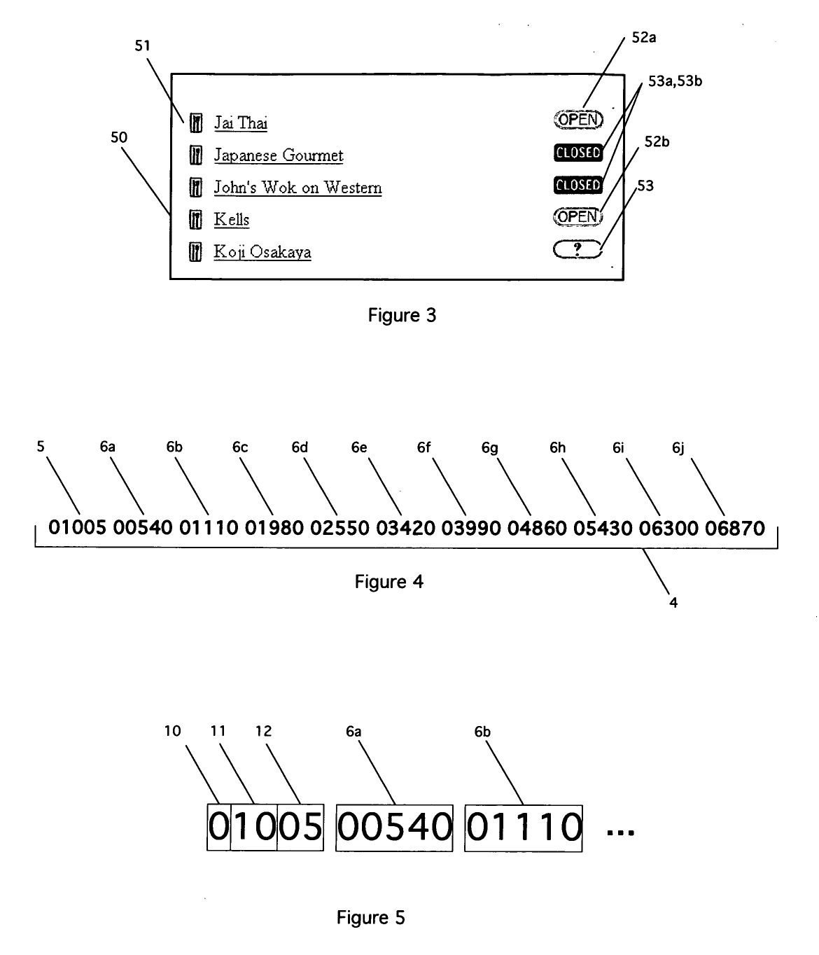

Referring now to FIG. 3, in another embodiment, the invention is applied to a web page that describes multiple businesses simultaneously. For each business depicted on web page 50, a place 52-53 is provided for the status of the business to be depicted. When it comes time for the web browser to display the status of a business with respect to a time criterion, a server side or client side script is called to evaluate the time-related information with respect to a time criterion and thereby determine the indicated state of the business, and return displayable graphical or textual information 52-53 representing the indicated state of the business. As can be seen in the example of FIG. 3, “open” status has been shown by means of a graphic 52a and 52b; “closed” status has been shown by means of a graphic 53a and 53b, and “unknown” status has been shown by means of a graphic 53. By this means the invention provides a way to examine the status of many businesses simultaneously for easy comparison of their accessibility with respect to a given time condition.

A preferred method of representing and processing time-related information for the purpose of carrying out the invention is now described in detail. As is common in the art, when a client web browser requests the web page that according to the manner of the invention will act as the information display, the server retrieves a text file that will serve as a basis for composition of the page source text to be delivered to the web browser. Alternatively the text may be dynamically generated, but for the purpose of discussion here, a text file will be assumed and referred to. Referring now to FIG. 4, said page source text includes one or more strings of characters 4 representing the time-related information pertinent to a given subject business. As further depicted by way of example in FIG. 4, the character group 5 represents meta information about the time-related information, and the character groups 6a-6j represent specific times of opening and closing during a base time schedule, as will be described below.

Referring now to FIG. 5, said meta information in character group 5 includes character(s) 10 that represent an initial state (open or closed) to be associated with the period of time if any between the reference time and the first scheduled time in the list of opening and closing times. In this example, the value “0” represents an initial state of “closed”.

Character group 5 also includes character(s) 12 representing a style of schedule period applicable to the time-related information. For example, hours of operation are preferably described in terms of a weekly repeating schedule period because business hours typically repeat on a weekly schedule such that a given day of the week always or almost always has the same opening and closing time. In the example of FIG. 5, the characters 12 “05” are taken to represent a weekly schedule period. However it is possible that hours for some businesses might be representable on a different schedule period, in which case characters 12 would be accordingly different. For example, a business that has the same schedule every day could be represented on a daily repeating schedule period rather than a weekly one. Alternatively a business that generally follows a weekly schedule but has numerous exceptions due to observance of annual holidays, might best be represented by means of a yearly repeating schedule. Therefore styles such as monthly, yearly, seasonal, daily, hourly, and many other styles are anticipated; also a nonrepeating schedule is anticipated in the case of time-related information describing a single occurrence of an opening/closing event, such as might exist, for example, for a business that opens and closes only once in history, or an event that occurs only once. Optionally character group 5 may include additional character(s) 11 representing the number of character groups 6a-6j that represent scheduled times.

Characters or character groups 6a-6j represent a sequential series of scheduled opening and closing times during the schedule period. Each character group 6a-6j represents a time in minutes past a reference time associated with the style of schedule period specified in character group 5. For example, if the schedule period is weekly, the reference time might be established as 12:00 AM Monday. In this example, scheduled times are encoded as integers (representing the number of minutes past the reference time) with leading zeroes added as necessary for padding to five characters. This format is for example only and many other suitable formats will be apparent to those skilled in the art. Ordering and format of all abovedescribed characters and character groups may vary without departing from the spirit and scope of the invention.

The text file that acts as basis for the page source text (or alternatively the text dynamically generated) also includes instructions to the server to run a program or script prior to delivering page source text to the client web browser. The program or script performs evaluation of the time-related information relative the time condition, and returns information preferably in the form of text content, graphical content, or reference to said content (such as, for example, a directory/file path to content) to be included in the page source text. A preferred means of implementing the function of the program or script is via a server side implementation as is commonly known in the art, for example, by means of a server side include (ssi). For example, the text in the text file includes a call to a program or script to be run by the server, and includes the path to the program or script residing on the server as well as a query string that passes time-related and other necessary information to the program or script. The program or script receives the query string, and identifies a time condition applicable to evaluation of the business hours. By default this time condition is localized server time, translated to a value within the domain of the specified schedule style. Therefore in the case of business hours expressed on a weekly schedule, the default time condition is the current localized server time expressed in minutes since the reference time.

Those skilled in the art will recognize that other means are available to provide time-related information to the program or script for the purpose of carrying out the invention. For example, an alternate method might involve passing a business identification number to the program or script instead of the time-related information, and then using said number to look up the corresponding time-related information in a database. Yet another method would not involve a server side include but rather would invoke the program or script via an IMG tag in the HTML (hypertext markup langugage) source of the page, upon which the program or script would execute and return graphic image data depicting the indicated state and/or derived information. One advantage to use of a query string to transmit time-related information to the script, coupled with invoking the program or script by means of an IMG tag, is that the indicated state and/or derived information may be served remotely from a public server to any web page without requiring the owner of that page to maintain and access a database nor the owner's server to process a server side include directive.

Having been called and having received the necessary information, the program or script then may perform evaluation of the time-related information with respect to the time condition in the following manner. An initial state is assigned equal to the initial state specified in the meta information (e.g. meta information 5 in FIG. 4, or e.g. specifically initial state 10 in FIG. 5). Times in the schedule (e.g. 6a-6j FIG. 4) are then sequentially compared to the time represented by the time condition. If the time represented by the time condition is later than the current schedule time and also later than the next schedule time, the state is flipped to the opposite state. In this way a “current” state is maintained during the process, representing the state entered into at the most recently examined schedule time, and preventing the need to explicitly associate “open” or “closed” state with each individual schedule time. When the time represented by the time condition is finally found to fall between two schedule times, the “current” state is taken as the indicated state, and the process halts. If no scheduled time precedes the time represented by the time condition, the initial state defined in the string is taken as the indicated state.

The evaluation also includes calculation of derived information as follows: the amount of schedule time separating the immediately previous scheduled time (or the last scheduled time if the next scheduled time is the first time in the schedule) and the time represented by the time condition; the amount of schedule time separating the next scheduled time (or the first scheduled time if the previous scheduled time is the last time in the schedule) and the time represented by the time condition; the actual time of the next scheduled time; and the actual time of the previous scheduled time.

It is anticipated that other states may be returned or implied, corresponding to other potential situations other than “open” and “closed”. For example, a state such as “by appointment” or “hours vary” could be returned if the time-related information is found to represent a variable or indeterminate schedule. In such a case, this might be represented in the time-related information by means of a code provided in the meta information, or perhaps by omitting the schedule times from the time-related information, or perhaps by including a certain value as a schedule time, or in any other way known in the art.

The abovedescribed method of evaluation is for example only as a way of bringing about the advantages of the invention and in no way restricts or limits the scope of the invention. Having learned of the abovedescribed method employed in the preferred embodiment(s), alternate methods of achieving representation of time-related information in a text or other format, and processing of said time-related information in order to identify and display an indicated state corresponding to a time condition, will be apparent to anyone skilled in the art.

Another aspect of the invention addresses handling of exceptions to a weekly or other schedule by use of multiple representations of time-related information. For example, suppose that a business holds a weekly schedule of 9am-5pm Monday through Friday, but on national holidays, the business is closed. As previously suggested, this situation could be addressed by using a yearly schedule style instead of a weekly style, listing every opening and closing time, including the special schedule on holidays, for the whole year. However, it can also be addressed by use of a weekly schedule that represents the general 9-5 M-F schedule and a second supplementary yearly schedule that represents only holidays. The supplementary schedule would be processed before the weekly schedule and either override the result of the weekly schedule or have no effect. The supplementary schedule would carry a designation representing either “biased closed” or “biased open”. “Biased closed” indicates that if the evaluation of the supplementary schedule indicates that the business is closed at the time condition, it is taken to override the result of the weekly schedule, otherwise the result of the weekly schedule is taken to be correct. “Biased open” indicates that if the supplementary schedule indicates that the business is open at the time condition, it overrides the result of the weekly schedule, otherwise the result of the weekly schedule is taken as correct. Therefore, to represent closures on holidays, the supplemental yearly schedule might, for example, be designated “biased closed”, and describe the business as being open at all times except for the closures on holidays. If the evaluation of the supplementary schedule indicates that the business is closed (i.e., the time condition falls on a holiday), then the indicated state is “closed” and the weekly schedule need not be evaluated. If the evaluation of the supplementary schedule indicates that the business is open (i.e. the time condition does not fall on a holiday), then the weekly schedule is evaluated and its result is taken as the indicated state. The “biased closed” or “biased open” designation may be carried as an additional part of the meta information described previously.

While the foregoing example described application of the invention to business hours for a subject business, the abovedescribed aspects of the invention apply equally well to other types of time dependent information beyond the example that was described. For example, the invention covers any subject that can possess time-related information that relates states of the subject to a function of time, such as one-time or recurring events, happy hours, sales events, or any other type of one-time or recurring event for which states are predictable as a function of time.

In the foregoing example it was shown that the time related information could be represented by a string of text characters describing certain meta information and a sequence of weekly times in minutes. The invention is not limited to this specific format or medium and it will become apparent to anyone skilled in the art that the invention could employ any other valid format without departing from the spirit or scope of the invention. Some possibilities include use of multiple strings or representations to take care of exceptions to the repeating schedule, such as for holidays. Also as previously mentioned, time-related information may be looked up in a database rather than directly passed in a query string.

The meta information character group may carry additional information in addition to that already described, or be omitted entirely without departing from the spirit or scope of the invention. For example, it could include information representing the type of states to be associated with the data, or the meta information could be retrieved from a database rather than carried in the string.

In the previous discussion, it was assumed that the binary states associated with the initial state and the schedule times were “open” and “closed”. These states were not represented explicitly on the assumption that the program or script assumed these states. However, in a more diverse application where other binary states such as for example “hot” and “cold”, or “staffed” and “unstaffed”, are possible, the meta information could include a code representing which binary pair is applicable, in the same manner that the previous description of the meta information included a code representing schedule style. In addition to binary states such as “open” and “closed”, many other binary states may be related to time by the time-related information. For example, the states could correspond to “exists” and “does not exist”. Additionally the states need not be binary pairs. For example, for one-time events, three mutually exclusive states are possible, including “future”, “happening now”, and “past”. Additionally any number of alternative mutually exclusive states, such as “red”, “yellow”, “green” may be employed. Furthermore the states do not need to be mutually exclusive. For example, at a given time condition more than one state may apply, such as “cloudy”, “warm”, and “not raining”. In these non-binary or non-mutually exclusive cases, the time-related information would need to include information explicitly indicating which state each schedule time relates to, and whether it initiates the state or ends the state.

In the foregoing examples, schedule times represented in the time-related information were denominated in minutes past a reference time applicable to the schedule style. In other variations, schedule times may be denominated in any unit of time, such as minutes, seconds, hours, days, millennia, milliseconds, and so on. The specific unit to be associated with a given piece of time-related information may be indicated by means, for example, of a code in the meta information character group, a code attached to each character group representing a schedule time, or assumed by the program or script that processes it.

In the foregoing example, business hours for a business was the type of time-related information represented, and therefore the schedule depiction was a table of days of the week on one edge and time of day on the perpendicular edge. For other schedule styles, such as monthly, a different format would naturally be applied. For example, a monthly schedule could be represented on a month calendar, or a yearly schedule on a yearly calendar. If the full schedule does not easily fit on a single display screen, the schedule might be provided with scrolling and/or zooming controls.

The time condition employed for determining an indicated state may be a default time such as for example current server time, or localized current server time, or a fixed or variable time related or unrelated to current time; or a user-specified time; or a default time modified by an offset specified by the user; or a default time modified by a default offset, or a current or user-specified time modified by an offset derived from an estimated travel time from the user's specified or detected location to the location of the subject, or similar combinations.

The time condition may consist of more than one time point or time period. In this disclosure, it is to be understood that the phrase “time condition” may apply to a time condition consisting of multiple time points or one or multiple time periods as well as to a single time point or single time period. For example, a time period could be employed as a time condition by specifying two times, one corresponding to the beginning of the period and the other corresponding to the end of the period. Both times would then be evaluated with respect to the time-related information, and both evaluations would return information about the indicated state and/or derived information corresponding to each of the times. In this way any number of times may be employed as the time condition.

The invention also may provide a means for user-specification of the time condition, such as via an interactive form and edit box provided on the information display such as a web page, an interactive depiction of a clock, an interactive depiction of a calendar, or any other suitable method of user input of date and/or time information.

It will be seen that the invention may also be applied to information displays other than a web browser displaying a web page. For example, any computer program that displays time-related information, perhaps pulled from a locally stored database rather than accessed across the internet, may also utilize this technique to express time-related information that relates a set of states to time. Several specific anticipated applications include but are not limited to: (1) a web page describing a single business, with status depicted for that business as already described; (2) a web page that shows a list or other grouping of businesses, with status depicted for each as already described; (3) a web page that shows a map of businesses, with status depicted as a modification of the depicted appearance of each mapped business, for example, by means of depiction in a given color to depict open status, a different given color to depict closed status, and a yet different color to depict unknown status; or alternatively by superimposition of symbols representing these states, etc; (4) a dynamically generated digital map running on a desktop computer, with similar coloration or symbolization to represent states of depicted businesses as described in (3); (5) examples 1-4 above showing any other type of entity having time-related information, other than businesses, such as for example, one-time or recurring events. These examples of information displays that the invention may be applied to are provided for illustrative example only and in no way restrict the spirit and scope of the invention, as anyone skilled in the art may now anticipate additional applications that may employ the invention.

I claim:

1. A method for display of time-related information, such information being descriptive of one or more predictable states of a described subject as a function of time, comprising:
Representation of said time-related information relating one or more states of the subject to a representation of time;
Determination of a time condition applicable to evaluation of said time-related information for the purpose of identifying the corresponding state(s), said time condition consisting of one or more time point(s) or time period(s);
Identification of one or more indicated state(s) corresponding to the time condition by means of evaluation of said time-related information with respect to the time(s) represented by the time condition;
Representation of said indicated state(s) and/or said derived information on an information display.

2. The method of claim 1 in which the time condition is a current localized server time.

3. The method of claim 1 in which the time condition includes one or more time(s) or period(s) of time specified by the user by means of a provided user interface.

4. The method of claim 1 in which the time condition is a current localized server time offset by an estimated travel time between the user's location and the location of the subject.

5. The method of claim 1 in which said evaluation of time-related information additionally comprises the derivation of information, said derived information including any combination or all of:
the amount of time between the time(s) represented by the time condition and the time of the next scheduled change of state;
the amount of time between the time(s) represented by the time condition and the time of the previous scheduled change of state;
the scheduled time of said next scheduled change of state;
the scheduled time of said previous scheduled change of state;
one or more measure(s) of the degree of nearness in time of said next scheduled change in state relative to the time(s) represented by the time condition;
one or more measure(s) of the degree of nearness in time of said previous scheduled change in state relative to the time(s) represented by the time condition.

6. The method of claim 1 additionally comprising depiction of the time-related information on a schedule.

7. The method of claim 1 additionally comprising depiction of the time-related information on a schedule by means of hyperlink from said representation of indicated states(s) and/or derived information.

8. The method of claim 1 in which said subject is a business and said time-related information is the weekly scheduled business hours of operation and said states are “open” and “closed”.

9. The method of claim 1 in which said subject is one instance of occurrence of an event, and said time-related information is the start time and end time of the event, and said states are representative of a future status of the event relative a time condition, a past status of the event relative a time condition, and a currently happening status of the event relative a time condition.

10. The method of claim 1 in which said subject is a regularly recurring event, and said time-related information is the start time and end time of the event relative a time point within a time frame within which the event cycles or recurs, and said states are representative of a future status of the next scheduled occurence of the event relative a time condition, a past status of the event relative a time condition, and a currently happening status of the event relative a time condition.

11. The method of claim 1 in which said time-related information is represented by means of one or more string(s) of text, comprising:
One or more set(s) of characters representing time(s) relative an implied reference time at which the state of the subject is scheduled to change from one state to another;
One or more set(s) of characters representing an initial state applicable to the period of schedule time between the reference time and the first scheduled change of state if any.

12. The method of claim 1 in which said time-related information is represented by means of one or more string(s) of text, comprising:
One or more set(s) of characters representing time(s) relative a reference time at which the state of the subject is scheduled to change from one state to another;
One or more set(s) of characters representing a style of schedule, that implies a time frame in which the reference time is the beginning point and in which the time(s) representing changes in state of the subject are schedule times scheduled relative the reference time;
One or more set(s) of characters representing an initial state applicable to the period of schedule time between the reference time and the first scheduled change of state if any.

13. The method of claim 12 in which the indicated state of the subject corresponding to the time condition is determined in a manner comprising:
converting the time condition to the equivalent schedule time if the time condition is defined relative a different time frame than that associated with the schedule style;
setting a variable to be equal to said initial state;
sequential comparison of consecutive schedule times to the time represented by the time condition;
changing the state represented by the variable to an opposite state if the time represented by the time condition is later than the scheduled time under comparison and also later than the next sequential schedule time if it exists;
halting the process and returning as the indicated state the state currently represented by the variable, if the time represented by the time condition is found to be later than the scheduled time under comparison and earlier than or equal to the next sequential scheduled time if it exists;
halting the process and returning as the indicated state the initial state, if no scheduled time is found to precede the time represented by the time condition.

14. The method of claim 5 in which said subject is a business and said time-related information is the weekly scheduled business hours of operation and said states are “open” and “closed”.

15. The method of claim 5 in which said subject is one instance of occurrence of an event, and said time-related information is the start time and end time of the event, and said states are representative of a future status of the event relative a time condition, a past status of the event relative a time condition, and a currently happening status of the event relative a time condition.

16. The method of claim 5 in which said subject is a regularly recurring event, and said time-related information is the start time and end time of the event relative a time point within a time frame within which the event cycles or recurs, and said states are representative of a future status of the next scheduled occurence of the event relative a time condition, a past status of the event relative a time condition, and a currently happening status of the event relative a time condition.

17. The method of claim 11 in which said subject is a business and said time-related information is the weekly scheduled business hours of operation and said states are “open” and “closed”.

18. The method of claim 13 in which said subject is a business and said time-related information is the weekly scheduled business hours of operation and said states are “open” and “closed”.

19. The method of claim 11 in which said subject is one instance of occurrence of an event, and said time-related information is the start time and end time of the event, and said states are representative of a future status of the event relative a time condition, a past status of the event relative a time condition, and a currently happening status of the event relative a time condition.

20. The method of claim 13 in which said subject is a regularly recurring event, and said time-related information is the start time and end time of the event relative a time point within a time frame within which the event cycles or recurs, and said states are representative of a future status of the next scheduled occurence of the event relative a time condition, a past status of the event relative a time condition, and a currently happening status of the event relative a time condition.
